(19) United States
(12) Patent Application Publication
(10) Pub. No.: US 2009/0001629 A1
(43) Pub. Date: Jan. 1, 2009

(54) Method for the production of low density oriented polymer composite

(75) Inventors: William R. Newson, Kent, WA (US); Alkiviadis G. Dimakis, Federal Way, WA (US)

Correspondence Address: WEYERHAEUSER COMPANY;INTELLECTUAL PROPERTY DEPT., CH 1J27, P.O. BOX 9777, FEDERAL WAY, WA, 98063, US

(73) Assignee: Weyerhaeuser Co., Federal Way, WA (US)

(21) Appl. No.: 11/771,247

(22) Filed: Jun. 29, 2007

(51) Int. Cl. B29C 45/14

(52) U.S. Cl. 264/229

(57) ABSTRACT

A process and material therefrom is described where a material comprised of a continuous orientable polymer matrix with one or more discontinuous or continuous second phases is stretched in the solid state using more than one device to apply force to the unoriented material to form a material that consists of a continuous oriented polymer matrix with one or more other phases. At least one of the phases releases from the oriented polymer matrix forming voids during the orientation process, thereby reducing the density to less than that of the original unoriented mixture. One or more of the phases may stay bonded to the continuous oriented polymer phase, acting as a reinforcing agent and forming no voids. Methods for forming such a material allowing for the control of the final shape and affecting the final density independent of the composition are also disclosed.

### FIELD OF THE INVENTION

This invention relates generally to the production of oriented polymer composite materials and materials therefrom.

### BACKGROUND OF THE INVENTION

The process of solid-state extrusion is known. Extrusion processes that are used include ram extrusion and hydrostatic extrusion. Ram extrusion utilizes a chamber in which polymer billets are placed, one end of the chamber containing a die and the other end an axially mobile ram. The billet is placed within the chamber such that the sides of the billet are touching the sides of the chamber. The mobile ram pushes the billets and forces them through the die. The shape of the material produced depends on the design of the die.

In hydrostatic extrusion processes, the billet is of a smaller size than the chamber and does not come into contact with the sides of the chamber. The chamber contains a pressure generating device at one end and a die at the other. The space between the billet and the chamber is filled with a hydraulic fluid, pumped into the chamber at the end containing the pressure generating device. During operation, pressure is increased on the hydraulic fluid and this in turn transmits pressure to the surface of the billet. As the billet passes through the die some of the hydraulic fluid adheres to the surface of the billet, providing additional lubrication to the process. The shape of the material produced depends on the design of the die.

Both processes produce a polymer that is oriented in a longitudinal direction, having increased mechanical properties, such as tensile strength and stiffness. However, the orientation in a longitudinal direction can also make the polymer weak and subject to transverse cracking or fibrillation under abrasion. The process of pushing the polymer through a die can also create surface imperfections caused by frictional forces. The shape produced is fixed by the die used and cannot be modified without stopping the process and changing the die.

U.S. Pat. No. 5,204,045 to Courval et al. discloses a process for extruding polymer shapes with smooth, unbroken surfaces. The process includes heating the polymer shape to below the melting point of the polymer and then extruding the polymer through a die that is heated to a temperature at least as high as the temperature of the polymer. The process also involves melting a thin surface layer of the polymer to form a thin, smooth surface layer. The process produces a material of a uniform appearance and subsequent commercial applications are limited as a result.

U.S. Pat. No. 6,210,769 to DiPede et al. discloses an oriented strap of polyethylene terephthalate with a surface layer that has been coextruded of a material that has been impact modified to increase its toughness The strap may also have its surface flattened by the application of heat.

However, a need still exists for a material that has improved mechanical properties by the use of orientation, improved economics by the reduction of its density, as well as improved surface characteristics by the modification of its surface structure.

### BRIEF DESCRIPTION OF THE DRAWINGS

The embodiments of the present invention are described in detail below with reference to the following drawings.

FIG. 1 illustrates a schematic of the process;

FIG. 2 illustrates an example of a stretching die with fixed dimensions;

FIG. 3 illustrates an example of an adjustable stretching die;

FIG. 4 illustrates the effect of back tension on the shape of the final part with increasing stretch ratio from Example 1;

FIG. 5 illustrates the effect of increasing stretch ratio on the density of the final part from Example 1;

FIG. 6 illustrates load vs. deformation behavior on a part from Example 1;

FIG. 7 illustrates the effect of the stretch ratio on Modulus of Elasticity (MOE) on a part from Example 1;

FIG. 8 illustrates the effect of the stretch ratio on Modulus of Rupture (MOR) on a part from Example 1;

FIG. 9 illustrates the effect of increasing stretch ratio on the shape of the final part from Example 2 at various die outlets to incoming part thickness ratios (DTRs);

FIG. 10 illustrates the effect of increasing stretch ratio on the density of the final part for various DTRs in Example 2;

FIG. 11 illustrates the effect of increasing stretch ratio on the MOE of the final part for various DTRs in Example 2

FIG. 12 illustrates the effect of increasing stretch ratio on the MOR of the final part for various DTRs in Example 2

FIG. 13 is an electron micrograph illustrating the stricture formed when a void forming filler is used;

FIG. 14 is an electron micrograph illustrating the structure formed when a non-void forming filler is used, from Example 3;

FIG. 15 illustrates the effect of stretch ratio on final part dimensions using a fixed stretching die and back tension, from Example 4;

FIG. 16 illustrates a schematic of a surface melting apparatus described in Example 6;

FIGS. 17 and 18 show electronic micrographs of part surfaces with and without surface treatment described in Example 7; and

FIG. 19 shows a density X-ray scan of the part described in example 7 with surface treatment;

FIG. 20 shows a density X-ray scan of the part described in example 7 without surface treatment;

FIG. 21 illustrates the decrease in density of the part described in Example 5 with increasing stretching ratio; and

FIG. 22 is a flowchart of a system and method in an embodiment of the present invention.

### DETAILED DESCRIPTION OF THE INVENTION

In an embodiment, the invention involves the process of orienting a polymer material containing multiple phases in the solid state. This is accomplished by stretching the material in the solid state. In addition to the formation of an oriented polymer structure, internal voids are also formed in the material during the stretching thus reducing its density.

In an embodiment, a method is provided for producing an oriented composite material. The method has the steps: combining an extrudable polymer with one or more fillers to form a starting material; heating and extruding the starting material into a first column; adjusting the temperature of the first column to a stretching temperature; presenting the first column to a stretching die and causing the first column to exit the stretching die in a second column having a cross-sectional area less than that of the first column wherein a back tension force is applied on the first column before the first column enters the stretching die; and applying a pulling force to the second column to stretch the first column through the stretching die at a rate sufficient to cause orientation of the polymer and to cause the second column to diminish in density to form the composite material.

In an embodiment, the one or more fillers are selected from a group consisting of cellulosic materials, mineral fillers, engineered fillers and industrial wastes.

In an embodiment, the one or more fillers are at least one of gas, liquid or solid. In an embodiment, the polymer is selected from the group consisting of: polyethylene, polypropylene, polyvinylchloride, polylacticacid, nylons, polyoxymethylene, polyethylene terephthalate and polyethyletherketone.

In an embodiment, the extrudable polymer is present in an amount of from 100 to 20 percent by weight in the starting material.

In an embodiment, the composite material has a density of from 0.3 to 0.9 of the density of the starting material.

In an embodiment, a method is provided for producing an oriented composite material. The method has the steps of: combining an extrudable polymer with one or more fillers wherein each filler is in solid, liquid, or gas form, to form a starting material; heating and extruding the starting material into a first column; adjusting the temperature of the first column to a stretching temperature; presenting the first column to a stretching die and causing the first column to exit the stretching die in a second column having a cross-sectional area less than that of the first column; and applying a pulling force to the second column to stretch the first column through the stretching die at a rate sufficient to cause orientation of the polymer and to cause the second column to diminish in density to form the composite material.

In an embodiment, the method has the further step of applying a back tension force to the first column before the first column enters the stretching die.

In an embodiment, a method is provided for producing an oriented composite material. The method has the steps of: combining an extrudable polymer with one or more fillers wherein each filler is in solid, liquid, or gas form, to form a starting material; heating and extruding the starting material into a first column; adjusting the temperature of the first column to a stretching temperature; presenting the first column to a stretching die and causing the first column to exit the stretching die in a second column having a cross-sectional area less than that of the first column wherein a back tension force is applied on the first column before the first column enters the stretching die; and applying a pulling force to the second column to stretch the first column through the stretching die at a rate sufficient to cause orientation of the polymer and to cause the second column to diminish in density to form the composite material.

In an embodiment, the composite material has a density of from 0.3 to 0.9 of the density of the starting material.

In an embodiment, the extrudable polymer is present in an amount of from 95 to 20 percent by weight ill the starting material.

In an embodiment, a method is provided for producing an oriented composite material. The method has the steps of: combining an extrudable polymer with one or more fillers to form a starting material wherein the filler is applied via at least one process selected from the group consisting of: physical blowing, chemical blowing, and expandable microspheres; heating and extruding the starting material into a first column; adjusting the temperature of the first column to a stretching temperature; presenting, the first column to a stretching die and causing the first column to exit the stretching die in a second column having a cross-sectional area less than that of the first column; applying a pulling force to the second column to stretch the first column through the stretching die at a rate sufficient to cause orientation of the polymer and to cause the second column to diminish in density to form the composite material.

In an embodiment, a method is provided for producing an oriented composite material. The method has the steps of: combining an extrudable polymer with one or more fillers to form a starting material which is a foam having a density less than a density for the extrudable polymer; heating and extruding the starting material into a first column; adjusting the temperature of the first column to a stretching temperature; presenting the first column to a stretching die and causing the first column to exit the stretching die in a second column having a cross-sectional area less than that of the first column wherein a back tension force is applied on the first column before the first column enters the stretching die; and applying a pulling force to the second column to stretch the first column through the stretching die at a rate sufficient to cause orientation of the polymer and to cause the second column to diminish in density to form the composite material.

In an embodiment, a method is provided for producing an oriented composite material, the process comprising the steps of combining an extrudable polymer with one or more compounds to form a starting material wherein the compound is applied via at least one process selected from the group consisting of: physical blowing, chemical blowing, and expandable microspheres; heating and extruding the starting material into a first column; adjusting the temperature of the first column to a stretching temperature; presenting the first column to a stretching die and causing the first column to exit the stretching die in a second column having a cross-sectional area less than that of the first column wherein a back tension force is applied on the first column before the first column enters the stretching die; and applying a pulling force to the second column to stretch the first column through the stretching die at a rate sufficient to cause orientation of the polymer and to cause the second column to diminish in density to form the composite material.

In an embodiment, a method is provided for producing an oriented composite material. The method has the steps of: combining an extrudable polymer with one or more fillers to form a starting material; heating and extruding the starting material into a first column; adjusting the temperature of the first column to a stretching temperature; presenting the first column to a stretching die and causing the first column to exit the stretching die in a second column having a cross-sectional area less than that of the first column; applying a pulling force to the second column to stretch the first column through the stretching die at a rate sufficient to cause a degree of orientation of the polymer and to cause the second column to diminish in density to form the composite material: and forming a surface of increased toughness on the composite material.

In an embodiment, the method has the further step of cooling the surface.

In an embodiment, the method has the further step of smoothing the surface.

In an embodiment, the method has the further step of cooling and smoothing the surface simultaneously.

In an embodiment, the increased toughness is provided by heating of the surface performed by a non-contact heating method.

In an embodiment, the non-contact heating method is selected from the group consisting of: hot air, infra red radiation, and direct flame heating.

In an embodiment, the increased toughness is provided by heating of the surface performed by a contact heating method.

In an embodiment, the contact heating method is selected from the group consisting of: heated plates, moving belts or rotating cylinders.

In an embodiment, the increased toughness on the surface of the composite material is provided by heating the surface to lower the degree of the orientation of the polymer at the surface of the composite material.

In an embodiment, the surface of the composite material is covered with a second material that is of higher durability than the composite material.

In an embodiment, a method is provided for producing in oriented composite material. The method has the steps of: combining an extrudable polymer with one or more fillers to form a starting material which is a foam having a density less than a density for the extrudable polymer; heating and extruding the starting material into a first column; adjusting the temperature of the first column to a stretching temperature; presenting the first column to a stretching die and causing the first column to exit the stretching die in a second column having a cross-sectional area less than that of the first column; applying a pulling force to the second column to stretch the first column through the stretching die at a rate sufficient to cause a degree of orientation of the polymer and to cause the second column to diminish in density to form the composite material; and forming a surface of increased toughness on the composite material.

In an embodiment, a method is provided for producing an oriented composite material. The method has the steps of: combining an extrudable polymer with one or more fillers to form a starting material; heating and extruding the starting material into a first column; adjusting the temperature of the first column to a stretching temperature; presenting the first column to a stretching die and causing the first column to exit the stretching die in a second column having a cross-sectional area less than that of the first column wherein a back tension force is applied on the first column before the first column enters the stretching die; applying a pulling force to the second column to stretch the first column through the stretching die at a rate sufficient to cause a degree of orientation of the polymer and to cause the second column to diminish in density to form the composite material, and forming a surface of increased toughness on the composite material.

### 1. Raw Materials

### 1a. Continuous Orientable Polymer Phase (Primary Phase)

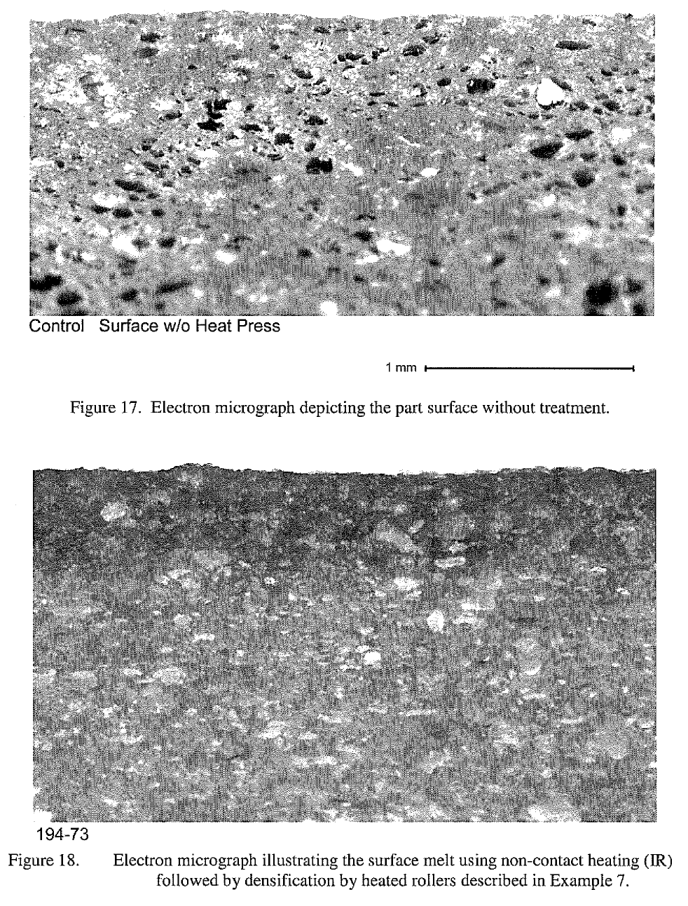

Any thermoplastic resin that can be oriented in the solid state by stretching is a candidate for the primary phase. For example: Polyethylene, Polypropylene, Polyvinylchloride, Polylacticacid, the members of the Nylon family, Polyoxymethylene, Polyethylene terephthalate, Polybutelene terephthalate, Polyethyletherketone, liquid crystal polyesters and the like. A plurality of resins can be used. If the plurality of resins forms a single phase when mixed, this single phase mixture forms the continuous matrix phase (indicated by 100 in FIG. 19). If a plurality of resins are used and they are not miscible in one another when mixed, but both form continuous phases, they are both matrix phases.

The matrix phase is the continuous material that surrounds any other phases present. That is to say that any point in the matrix phase is connected to all other points in the matrix phase by the matrix material, the continuous phase in not made up of individual domains but a continuous material that is throughout the entire part. This includes situations where there are 2 or more continuous phases, so called “interpenetrating networks” of more than one phase where both phases are continuous but do not dissolve in one another.

### 1b. Secondary Phases

Secondary phases are substances that can be mixed with a chosen primary phase (described in 1a). In order to be successful, a secondary phase (indicated by 102 in FIG. 19) must be thermally stable at the processing temperature of the thermoplastic polymer. The secondary phases can be a gas, solid, or liquid at the orientation temperature.

If one or more of the secondary phases are polymers, they may be incompatible with the continuous orientable phase (described in 1a) and form distinct and separate phases (i.e., similar to interactions between oil and water). The polymeric component(s) present in the lesser amount may form a separate phase that has an interfacial strength with the matrix phase that is less than the stress applied to the interface during stretching and behaves substantially similar to a solid filler during stretching.

Examples of secondary phases that form voids on stretching include, but are not limited to, cellulosic particles (such as wood flour and similar wood residues), calcium carbonate, talc, magnesium hydroxide, fly ash, silica, agricultural residues, and other polymers, etc. To form voids during stretching, the bond at the surface between the matrix and the secondary phases fails under the stresses applied during stretching. Some materials may form interfaces that are naturally incompatible, while some may require the application of a coating to the secondary phase or the addition of additives to the matrix phase to modify the interface.

For a secondary phase to act as a reinforcement without forming voids, the interface between the secondary phase and the matrix phase will be of a sufficient strength to withstand stresses during stretching. Some secondary phase materials may be naturally compatible with the matrix phase or may require being coated with a chemical agent to make them compatible and produce an interfacial bond of sufficient strength. Also, a chemical agent may be added to the material to react at the interface of the secondary phase and the matrix phase to improve the interfacial strength. Many methods for modifying the interface are known to those skilled in the art.

Secondary phases that are in the solid state during processing are generally referred to as fillers and are fairly small in dimensions including but not limited to particles that pass through a standard 20 mesh screen, to particles as small as a few nanometers. It should be noted that the term “filler” should be interpreted as being in gas, liquid or solid form, unless specified by example. For particles that have poor interfacial strength with the matrix, the aspect ratio of the particle is not a major factor as after stretching it will not be attached to the matrix, but the aspect ratio may be a factor for particles with interfacial strength that can withstand stretching where increased aspect ratios may be an advantage.

Some examples of fillers are cellulosic materials, such as wood flour, paper pulp, and cellulose microcrystals and nanocrystals; mineral fillers, such as calcium. carbonate, talc, limestone, mica, wallostonite, silica; engineered fillers, such as glass microspheres or microballoons; and may also include industrial wastes like fly ash. Essentially, any material may be incorporated that can be ground or supplied at a sufficient size to be processed in plastic processing equipment mixed in the matrix polymer.

The secondary phase can also be a gas. In the forming of gaseous bubbles in the orientable polymer matrix; to this end, processes generally referred to as foaming can be used. This foaming can be of three main types: physical gases that are injected into the melt during processing (physical blowing agents); materials that decompose to form gases during processing (chemical blowing agents); and gas-filled microspheres that expand during processing to reduce density (generally known by the tradename “EXPANCEL microspheres”). These materials are applied to reduce the density of the product before orientation using methods generally known to those skilled in the art of foam extrusion such as free foaming, and the “Celuka” process.

### 1c. Additives

In addition to the additives (indicated by 104 in FIG. 19) already mentioned to affect matrix-particle bonding, other additives may be included to improve extrusion performance. These may generally include lubricants, such as metallic stearates and ethenylene-bis-steramide, or organic lubricants, as well as colorants, and additives to increase the ultraviolet (UV) stability in service or thermal stability during processing and while in service. Also included are additives to increase the resistance to microbial attack. These additives are of the types generally known to those skilled in the art of polymer compounding.

### 2. Equipment/Process Steps

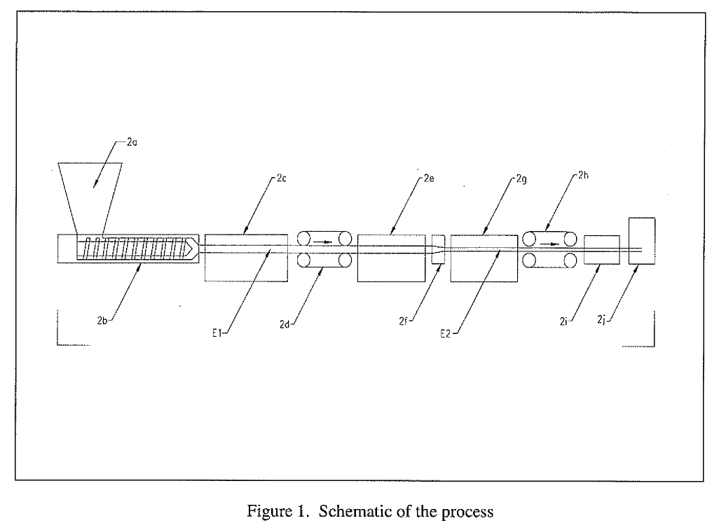

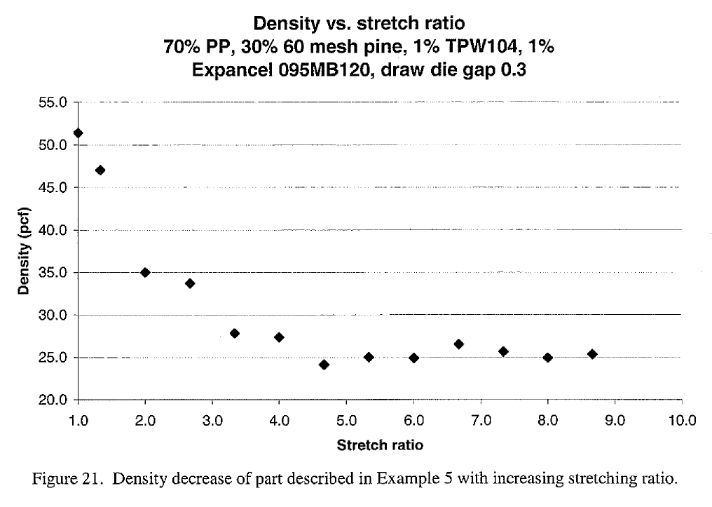

FIG. 1 shows a general schematic representation of the process equipment and process steps herein described, as corresponding with the headings used in this specification. Reference is also made to FIG. 22 which illustrates a flow chart of the process steps. The numbers in parentheses in FIG. 22 correspond to the numerals used to identify apparatus and steps in the headings of this specification.

### 2a. Material Preparation

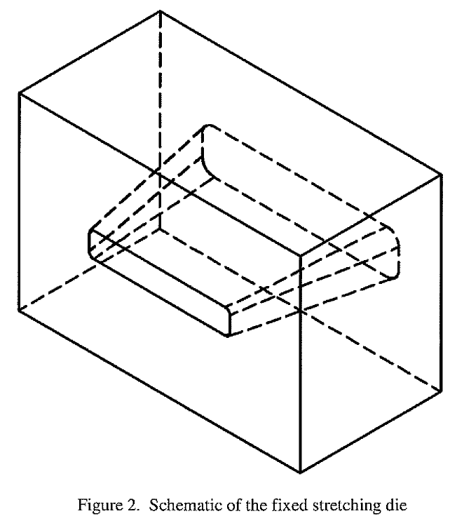

The materials (see section 1a-c) are prepared (as indicated by step 106 in FIG. 22 and 2a in FIG. 1) in accordance to how they are generally used in the polymer compounding industry. They can be pre-compounded into masterbatches containing one or more components that are blended and formed into pellets that are further blended with other feed materials prior to extrusion of the material. They are blended in their raw form and melted/mixed while extruding the final material or various combinations thereof as known to those skilled in the art of polymer compounding and extrusion. Raw materials containing components that become undesirable gases during processing (including water) are generally dried before processing, as is common in the art.

### 2b. Extrusion

Extruders (single, co-rotating twin, counter rotating twin, etc.), (as indicated by 108 in FIG. 22 and 2b in FIG. 1), are generally used to melt and mix the raw materials. The melted and mixed materials are pumped through a die that continuously forms the unoriented initial part (E1) comprised of the materials, as outlined in sections 1a-c. It is only required that the equipment form a continuous part of a prescribed shape that is sufficiently well mixed, as is common in the art or polymer extrusion. While poor mixing may affect the final part, mixing quality beyond that regularly seen in extrusion may not be required. The extruded part may have a reduced density compared to the starting components if physical or chemical blowing, agents or expanding microballoons (Expancel) are used during initial unoriented part extrusion. The initial part may contain the orientable thermoplastic resin and a plurality of secondary phases, as described above.

### 2c. Cooling

Depending on the desired part shape, calibration may be needed in combination with cooling (step 110 in FIG. 22) to maintain the product shape during cooling as is common in the art of plastic extrusion. For this specific process, the cooling time and temperature required will vary depending on the part shape and target temperature at stretching. Temperature can be in a range from 32 F to 120 F (this depends on the polymer chosen). The cooling and heating can depend on part geometry. In an example, cooling time is from about 50 sec to 25 min. Cooling can be performed using, for example, a water spray tank, as shown in FIG. 1 by reference numeral 2c.

### 2d. Extrusion Speed Control

After removing the desired amount of heat from the part, a piece of process equipment generally known as a “haul-off” or “puller” (indicated by 2d in FIG. 1 and step 112 in FIG. 22) is used to control the speed of the extrudate (E1). The pulling speed and the extrusion rate must match closely if a well formed part is to be manufactured. This practice is common in the art of polymer extrusion. Moreover, in the process, the puller or haul-off is required to resist pulling forces on the outlet side, in addition to the force required to move the part from the extrusion die through calibration, if used, and the cooling section (2c). Electromechanical controls for accomplishing this speed control using what is known as “braking” are of a type common in the industry. As the extrudate passes from the extrusion speed control device to the stretching die (indicated by 2f in FIG. 1 and 116 in FIG. 22), in a step described below, the part can be under considerable tension, which must be resisted by component (2d). Common devices for this purpose include but are not limited to: godet stands for parts that are flexible enough to pass through them, cleated pullers, belted pullers, wheel pullers and reciprocating pullers.

### 2e. Temperature Conditioning

To adequately control the temperature throughout the part it is usually necessary to include additional heating or cooling for a time sufficient to obtain a substantially even temperature distribution inside the part, as indicated by step 114 in FIG. 22 and 2e in FIG. 1. This temperature conditioning may constitute a simple insulated section, in a component such as a simple insulated tunnel, to allow the temperature to stabilize inside the extrudate, additional cooling with water or air, hot air or infrared ovens for heating or a combination thereof. The desired temperature at the end of stabilization will depend on the specific orientable thermoplastic polymer used as the continuous phase (1a), and to a lesser extent the temperature behavior of the secondary phase(s). The temperature window for stretching depends on the materials used.

### 2f. Stretching Die

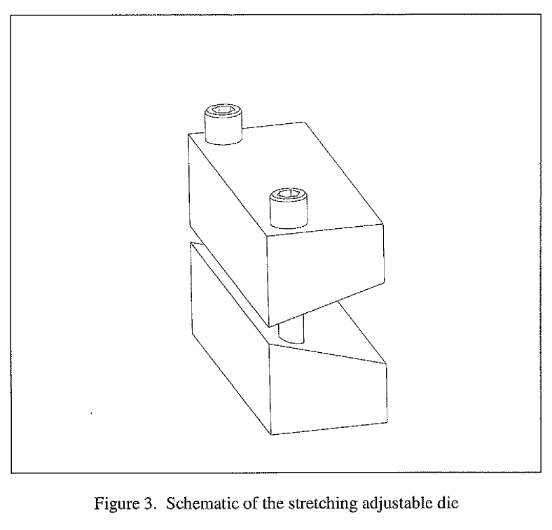

Some of the stretching force comes from the interaction of the initial extrudate with the stretching die (indicated by 2f in FIG. 1 and 116 in FIG. 22). The outlet of the stretching die is of a smaller cross sectional area than the cross sectional area of the initial extrudate (E1) passing through the stretching die. To pull the initial extrudate (E1) through the restriction of the stretching die requires the application of a pulling force. If this is the only source of force on the part at the stretching die exit, the interaction of the initial extrudate with the stretching die is difficult to control, as there are minor variations in the composition, shape, and temperature conditioning of the initial extrudate as it reaches the stretching die. In the case where the stretching die shape is fixed (such as when it is formed from a solid piece of metal, see FIG. 3) and the initial extrudate shape is fixed by the extrusion die, it is difficult to control the interaction of the stretching die with the initial extrudate (E1) to form the desired part (E2). This may result in poor control of and/or lack of flexibility in the final part size.

For a given initial extrudate geometry, stretching die geometry and process conditions, a certain final oriented part geometry (E2) will result when the initial extrudate (E1) is pulled through the stretching die (2f). If the extrudate geometry, extrudate composition or process conditions vary in any way, this will result in a change in the final oriented part geometry, as the force required by the interaction of the stretching die and initial extrudate will vary with the variations in geometry, extrudate composition or other process conditions. If the draw puller (2h), described below, is operated at a rate higher than that required to pull the extrudate through the stretching die, the speed the part moves into the stretching die will increase to a level higher than the extrudate speed at the exit of the extrusion speed control (2d). This will place the part in the temperature conditioning area into a state of “back” tension, stretching it very slightly. This tension force is added to the force required to pull the part through the stretching die, resulting in an increase in the total force on the part at the stretching die exit and increased stretching.

This combination force from the speed difference between the extrusion speed control (2d) and the stretching puller (2h) with the force to pull the material through the stretching die (2f) allows the operator to select the overall degree of stretching directly, thereby limiting the effect of the stretching die/extrudate interactions in determining the final part geometry (E2). Furthermore, it will be shown by example that an adjustable stretching die (see FIG. 2) or a stretching die with a geometry that deviates from the uniform shape of the extrudate can be used in conjunction with the speed difference between extrusion speed control (2d) and the stretching puller (2h) to produce a variety of shapes and physical properties.

It should be mentioned that the stretching die (2f) can take many forms that retain the primary purpose of increasing the force on the extrudate in order to contribute to the forces required to accomplish the orientation process.

If the orientation process is substantially started in the temperature conditioning section (2e), the final part shape is greatly affected by local variations in part temperature conditioning, part shape, and composition. Without an appropriately designed stretching die (2f), the part can choose to deform anywhere between the extrusion speed control (2d) and the stretching puller (2h) which can result in uneven final part (E2) dimensions. To avoid this, the tension on the part in the temperature conditioning section (2e) is maintained below the yield strength of the part (E2), thus avoiding substantial stretching before the stretching die. By adding enough force at the stretching die to cause the bulk of the stretching, it is ensured that only a small volume of material is undergoing orientation at any one time. Thus, all of he material may undergo a similar amount of orientation and achieve a similar size and the process is less susceptible to minor variations in the initial part size (E1), material composition, or local process conditions.

The amount of force generated at the stretching die must be adequate to initiate orientation, while the force on the part (E2) in the temperature conditioning section (2e) must be less than that required to initiate orientation before the extrudate reaches the stretching die. This is achieved by a balance between the level of restriction at the stretching die and the difference between the speeds of the extrusion speed control (2d) and the stretching puller (2h). This is illustrated in the examples below.

### 2g. Stretched Part Cooling

Some distance after passing through the stretching die, the part is cooled (as indicated by step 118 in FIG. 22 and 2g in FIG. 1) to help preserve the orientation induced during stretching, to cool the part for subsequent handling; at its stretching temperature, it is quite flexible and prone to warping during handling. The time and temperature of cooling required will depend on the final part shape and the desired final temperature for ease of handling for a specific material composition.

### 2h. Stretching Puller

The stretching puller (as indicated by step 120 in FIG. 22 and 2h in FIG. 1) must have a sufficient force capability to stretch the part. This depends on various factors, such as, the composition, operating conditions, degree of stretching and size of the part. Commonly available machines in the industry are adequate for this purpose. They include but are not limited to: godet stands for parts that are flexible enough to pass through, cleated pullers, belted pullers, wheel pullers and reciprocating pullers.

### 2i. Surface Toughening

Various methods can be used to provide a toughened surface (indicated by step 122 in FIG. 22 and 2i in FIG. 1) in order to increase the abrasion resistance and workability and surface properties of the product. The existence of molecular orientation in the product renders it susceptible to “splitting” due to the low transverse strength that is a result of orientation. This effect is most detrimental at the surface of the product where it is exposed to the forces of abrasion as well as when it is exposed to high levels of force from cutting tools. The main goal of surface toughening is to provide a surface where the “splitting” tendency of the oriented material is eliminated. In an embodiment, an unoriented polymer surface is provided by melting. In another embodiment, a coating of unoriented polymer is placed on the surface after orientation. In another embodiment, the surface is coated with a thermosetting polymer such as polyurethane or other coating.

The orientation can be substantially eliminated, thus improving surface durability by heating the surface above its melting point, thereby allowing the molecules to relax and returning them to their unoriented state which has isotropic properties and is not susceptible to the transverse splitting of the oriented state. This can be accomplished with heated plates, heated rollers, or indirect heating such as hot air or infra red radiation. Upon re-melting, the material may become rough due to retractive forces resulting form the previously oriented state. This roughened surface can be smoothed by the application of force through a roller which has the added benefit of densifying the formerly low density material that is now melted.

Another method of increasing the surface durability is by applying a coating of material to protect the surface from the forces that could cause transverse splitting. This coating call be the same composition as the substrate material or be substantially different depending on specific properties that are desired in the surface such as the addition of color, and additives for ultraviolet (UV) radiation resistance. This surface can be applied by extrusion coating similar to, for example, coating a wire with an insulating sheath, or, for example, when a film of coating is applied to paper. Other methods of obtaining this durable surface include curtain coating, vacuum coating, spraying, or the like, using materials like thermosetting resins such as polyurethanes, epoxies, or polyesters or air drying formulations commonly referred to as paints.

Depending on the method, surface toughening may be applied at positions other is than that shown in FIG. 1, such as between 2g and 2h, or in an offline process after the goods are cut at 2j.

### 2j. Traveling Saw

After exiting the puller, a traveling saw of the type common in the industry is used to cut the part to length while it is moving (as indicated by step 124 in FIG. 22 and by 2j in FIG. 1).

### 3. Operating Procedure

### 3a. Startup

The extruder is fed with the desired ingredients which are melted, mixed and pumped out of the extrusion die in a manner known to those skilled in the art according to the materials chosen. As the material flows out of the die, it is initially pulled at a rate greater than that used to make the desired part so that an undersized part is made. A sufficient quantity of this undersized part is produced to ensure that the operator can thread it through the restriction at the stretching die, on to the stretching puller (2h). After a sufficient amount of undersized part is made, the extrusion puller (2d) speed is slowly reduced until the initially extruded part (E1) is of the desired size for continuous operation.

This part which is the desired size for continuous operation, passes through the elements of the line until it reaches the stretching, die (2f). When the extruded part is of a cross sectional area that is larger than the exit area of the stretching die, the stretching puller speed is increased so that the rate of the material entering the stretching die (2f) is the same as, or faster than, the extrusion puller (2d) speed to prevent material from accumulating in the temperature conditioning area (2e). This will be higher than the extrusion speed as the stretching die requires some stretching of the part to pass through the stretching die as the exit area of the stretching die (2f) is now smaller than the extruded part size (E1). After the extruded part, which is of the desired size for continuous operation, has passed through the stretching die (2f), the speed of the stretching puller (2h) can be increased so that the speed of the part entering the stretching die (2f) is greater than the extrusion puller speed. This requires some stretching of the part in the temperature conditioning section (2e) as a braking force is applied by the extrusion puller (2d) in order to maintain the extrusion speed as required to make an extruded part (E1) of the desired size for continuous operation at the selected extrusion rate.

### 3b. General Operation

Once startup is achieved, the speed of the stretching puller (2h) can be changed at will to adjust the amount of stretching the part undergoes. The stretch ratio is determined by the extrusion puller (2d) rate and the stretching puller (2h) rate. Increasing the stretching puller (2h) speed increases the stretch ratio and decreases the part size without changing the stretching die (2f) configuration or initial extruded part size. This is a very substantial improvement over existing technology, in which the final part size is basically fixed for a certain initial part size and draw die configuration. This ability to change the stretch ratio by simply changing the speed of the draw puller allows for control of the final part size and for greater process stability. There may be a limit to the amount of tension that can be placed on the part in the temperature conditioning section (2e) before the material starts to substantially stretch there (2e) instead of at the stretching die (2f). This “free-drawing” in the temperature conditioning section (2e) tends to be poorly controlled and is generally to be avoided. The stretch ratio where this occurs depends on the amount of force applied due to tension at the extrusion puller (2d) from braking, and how much force is applied by the constriction of the stretching die (2f). The additional force placed on the part by the stretching die (2f) is used to initiate stretching and the bulk of the stretching occurs after the stretching die exit where the force on) the part is the sum of the braking force from the extrusion puller (2d) and the force required to pull the part through the stretching die (2f). Modifying the stretching die (2f) exit openings may change this balance. A stretching die (2f) with adjustable dimensions can be used to allow the adjustment of the force balance while operating (see FIG. 2).

### EXAMPLE 1

A mixture of 50 wt % polypropylene and 50 wt % ground calcium carbonate (CaCO₃) and process additives were mixed and extruded into a 2″×0.5″ unoriented extrudate, as is common in the art. This extrudate strip was calibrated for size and cooled in a common cooling tank. The extrudate then passed through a standard 36″×3″ belted puller at 1.5 ft/min. The extrudate then passed through a temperature conditioning section such that the surface temperature at the exit of the temperature conditioning section was approximately 265 degrees Fahrenheit as measured with an infrared pyrometer. The extrudate then moved through a plane strain stretching die whose outlet height is adjustable (see FIG. 3). Further, the extrudate passes through a common industry standard cooling tank and into an industry standard 48″×4″ cleated puller and sliding saw.

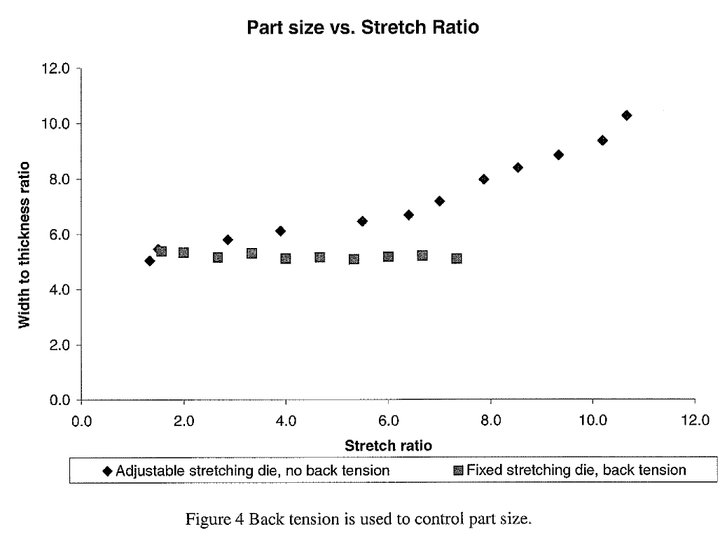

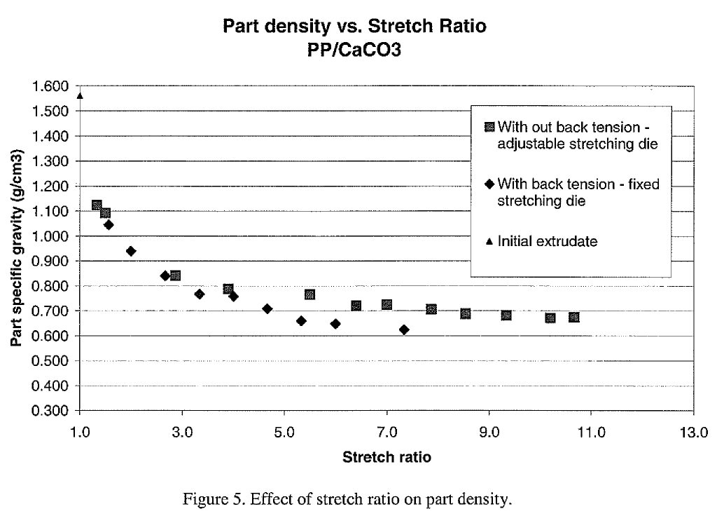

By adjusting the outlet dimensions of the stretching die and the speed of the 48″×4″ puller, various products can be produced, as seen in FIGS. 4 and 5. FIG. 4 shows the various part dimensions that can be obtained with this system by varying the speed of the 48″×4″ puller and/or the outlet height of the draw die.

In FIG. 4 it can also be seen how the width to thickness ratio of the final part increases from the initial extrudate due to the effect of the plane strain stretching die as the exit is restricted and no back tension is allowed (see FIG. 4, data marked “Adjustable Stretching Die, no Back Tension”). If at some point back tension is applied between the stretching die and puller 1 at a given die exit thickness/part thickness ratio (die thickness ratio, referred to as “DTR”), the width to thickness ratio of the final part follows a new path, even as the overall stretch ratio is increased (FIG. 4, data marked “Back Tension, DTR 1.35”).

This can be accomplished by increasing the speed difference between the extrusion puller and stretching puller, without modifying the DTR of the stretching die, thus increasing the back tension on the part between the extrusion puller and the stretching die. In the presence of back tension, adjusting the DTR and the overall stretching ratio while operating can achieve many different part geometries without changing tooling or disrupting production. In FIG. 5 the effect of the use of back tension on the product density can be seen.

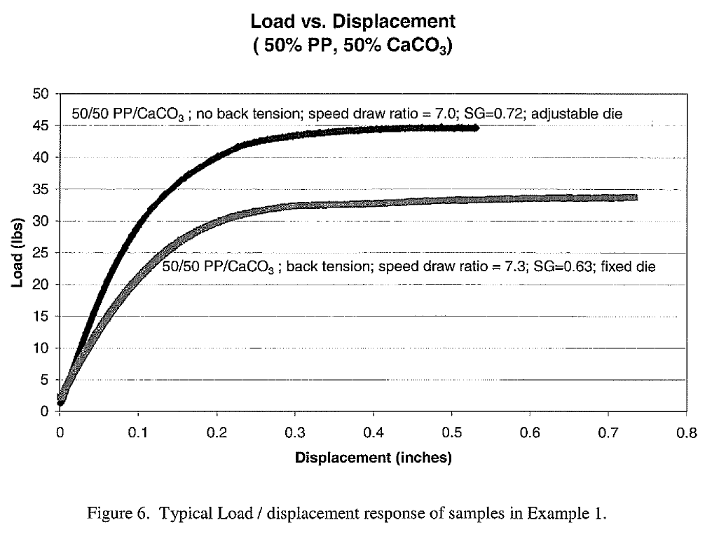

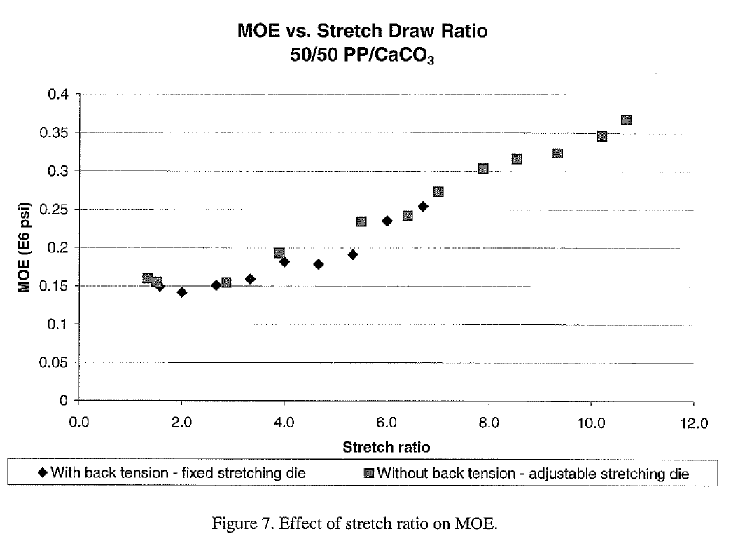

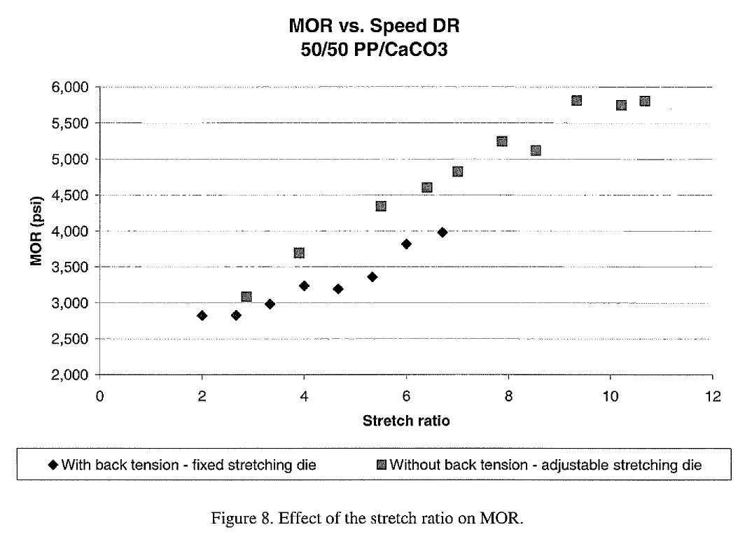

FIG. 6 shows the load vs. displacement response of typical Oriented Polymer Composite samples of Example 1, with and without back tension. The stretch ratio for both samples is the “same”, but the sample without back tension is of higher density. The secant modulus of elasticity (MOE) and modulus of rupture (MOR) of the sample without back tension and fixed stretching die is 273,000 psi and 4823 psi, respectively. The secant MOE and MOR of the sample with back tension and the fixed stretching die is 231,000 psi and 3502 psi, respectively. FIGS. 7 and 8 depict the effect of the stretch ratio on MOE and MOR, respectively.

### EXAMPLE 2

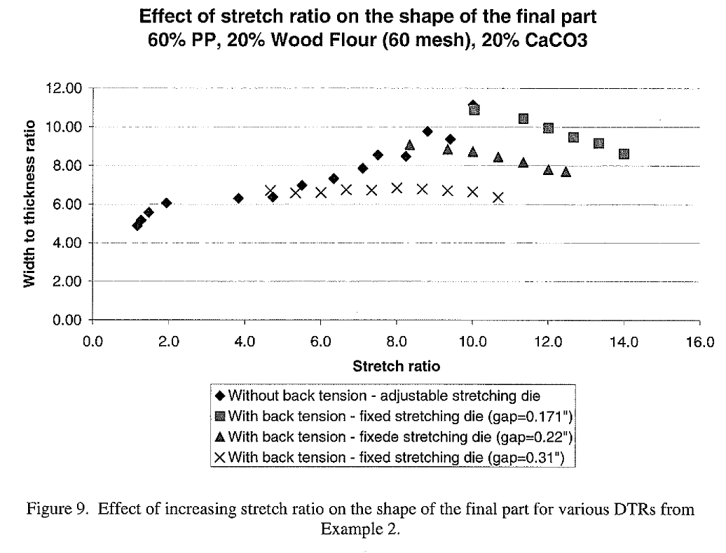

A mixture of 60 wt % polypropylene, 20% 60# wood flour, and 20 wt % ground calcium carbonate (CaCO₃) and process additives were mixed and extruded into a 2″×0.5″ unoriented extrudate, as is common in the art. An example of the ability to use back tension and an adjustable draw die is included for 3 different DTR's (see FIG. 9). During the experiments, conditions were found in which the back tension was so great that drawing occurred in the temperature conditioning area (the terminal stretch ratios for DTR 1.54 and 2.57) and where the part broke during drawing with hack tension at DTR 2.81 and broke under stretching with no back tension at a stretch ratio of 10, delineating the envelope of conditions where the technique could be used in this specific composition.

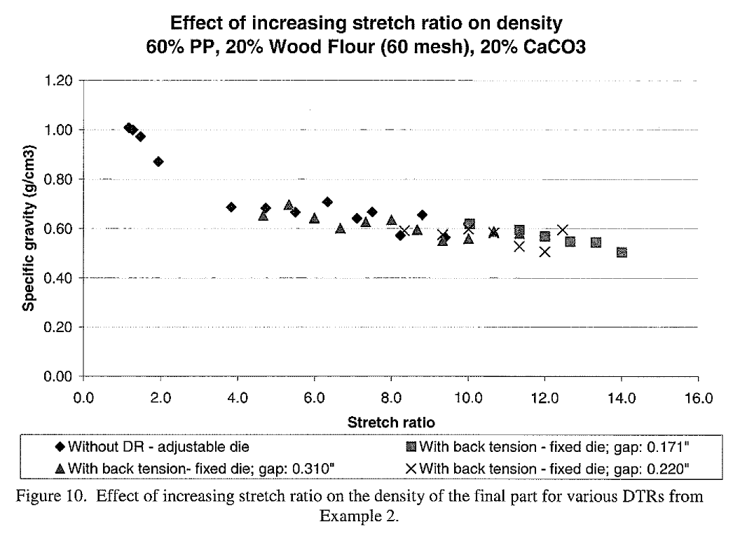

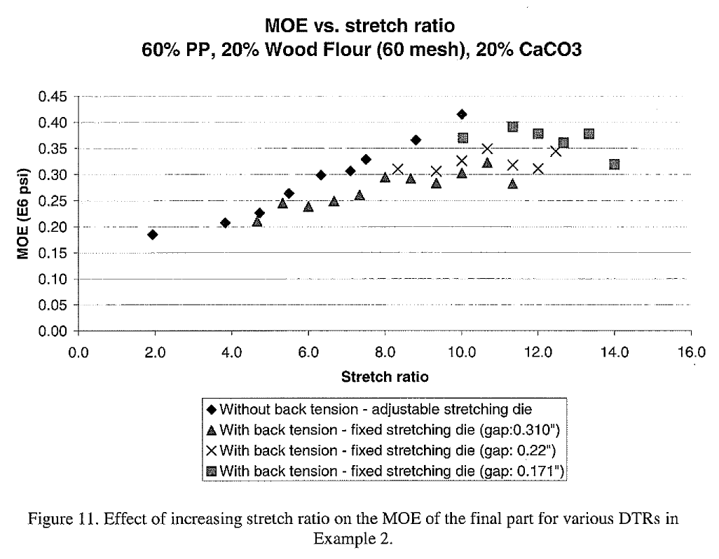

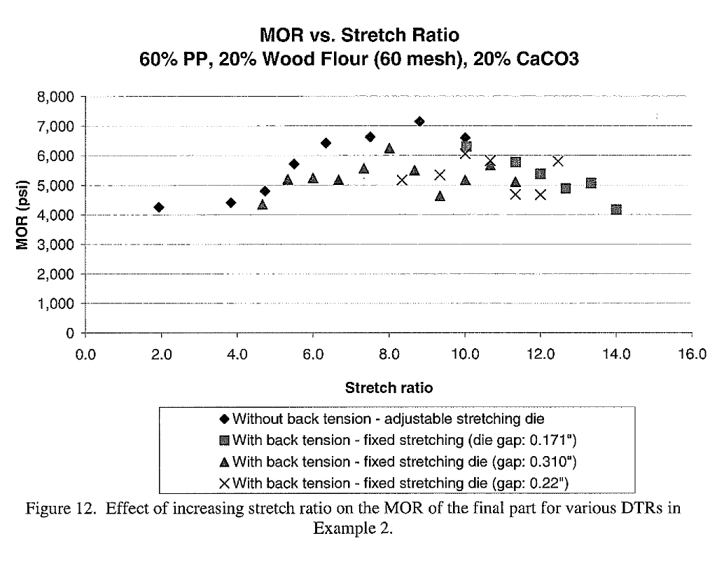

FIG. 10 shows the change in density with stretch ratio under the various conditions in EXAMPLE 2. In particular, the density reduction of the oriented part compared to the unoriented starting material is illustrated, being mainly dependent oil the stretch ratio. FIGS. 11 and 12 illustrate the effect of increasing stretch ratio on the MOE and MOR, respectively.

### EXAMPLE 3

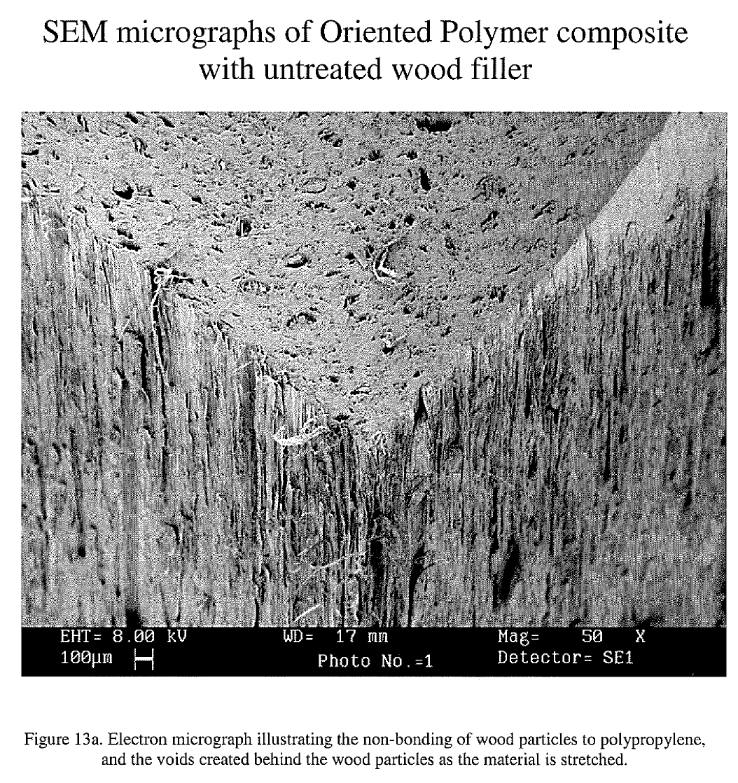

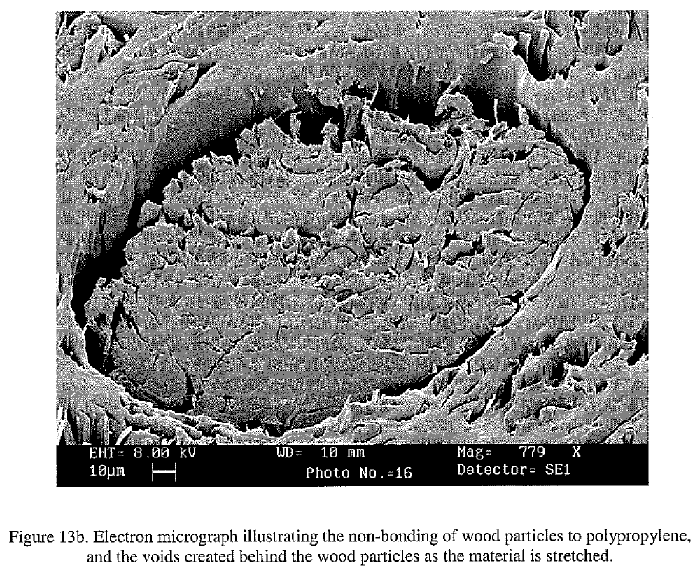

A mixture of 60 wt % polypropylene, 20% 60# wood flour, and 20 wt % of a ground calcium carbonate (CaCO₃) (different from the CaCO₃ in Example 2) and process additives were mixed and extruded into a 2″×0.5″ unoriented extrudate in a manner common in the art. Setting the DTR at 1.57 and varying the stretch ratio by setting a difference between puller 1 and puller 2 yielded materials with higher density and higher mechanical properties than the material containing untreated calcium carbonate (Example 2). From Example 2 at similar conditions, there was a density increase of 4.7% due to decreased void formation with the second type of calcium carbonate. Electron micrographs of the structures with void forming fillers and non-void forming fillers are shown in FIGS. 13 and 14, respectively. The electron micrograph in FIG. 13 illustrates the non-bonding of wood particles to polypropylene, and the voids created behind the wood particles as the material is stretched. The electron micrograph in FIG. 14 shows voids around the wood flour particles and the untreated calcium carbonate and to a lesser extent around the treated calcium carbonate.

### EXAMPLE 4

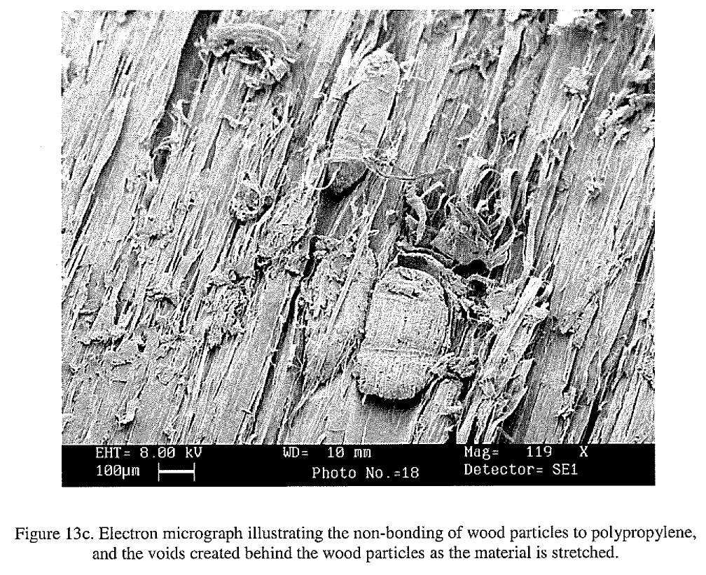

A mixture of 60 wt % polypropylene, 40% 60# wood flour, and process additives were mixed and extruded into a 2″×0.5″ unoriented extrudate as is common in the art. A uniform strain stretching die (FIG. 2) with an area ratio of unoriented part area/stretching die exit of 1.32 was used instead of the adjustable DTR die of Examples 1, 2, and 3. FIG. 15 shows the relatively constant thickness to width ratio of the product at various stretch ratios produced by changing the speed of puller 2 while keeping puller 1 constant, without modifying the tooling configuration to increase the stretch ratio. This shows the ability to change the overall part size while maintaining geometric similarity between the parts produced. This is useful for controlling the size of the manufactured part by adjusting puller 2 while continuously operating. At a stretch ratio of 5.3 and a DTR of 1.32, the formulation produced a part with all MOE of 144,000 psi, and an MOR of 1,981 psi at a density of 28.6 pcf.

### EXAMPLE 5

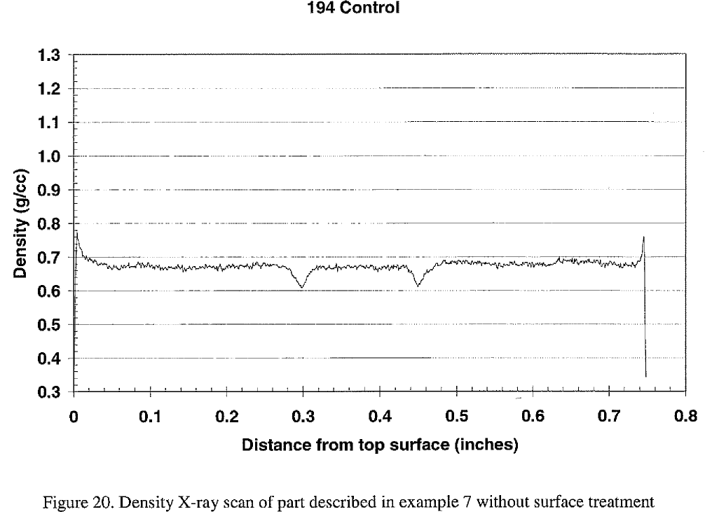

A mixture of about 69.4 wt % polypropylene, 29.6% 60# wood flour, 1% Expancel microspheres and process additives were mixed and extruded into a 2″×0.5″ unoriented extrudate as is common in the art. An adjustable plane strain stretching die (see FIG. 3) with a DTR of 1.56 was used with multiple differences between the speed of puller 1 and puller 2 to produce materials of varying stretch ratios. The use of the Expancel microspheres produced an unoriented starting material with a density of 51.4 pounds per cubic foot. This lowered initial density produced lightweight final products with a density of 24.9 pcf, MOR of 2,178 psi, and an MOE of 179,000 psi at a stretch ratio of 8. FIG. 21 shows the density decline with increasing stretching ratio. There is not a significant change in part density above a stretching ratio of 5.

### EXAMPLE 6

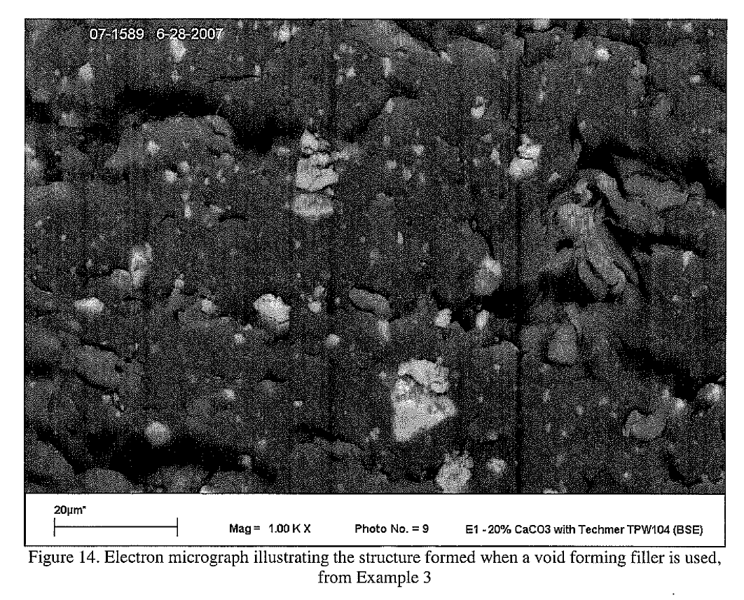

Starting material made from a mixture of 70 wt % polypropylene and 30% 60# wood flour stretched to a ratio of 6 to 1, was passed between 2, 30″ long heated plates with 3 temperature zones: 370 degrees F. at the entry, 370 degrees F. in the middle, and 340 degrees F. at the exit (see FIG. 16), moving at 8 feet per minute with a closing force on the part surface of about 125 psi. This procedure resulted in a re-melted surface of 0.0057″ (average) on the surface of the part. The overall average density of the part was 40.1 pcf and the average density of the remelted surface was 49.8 pcf.

### EXAMPLE 7

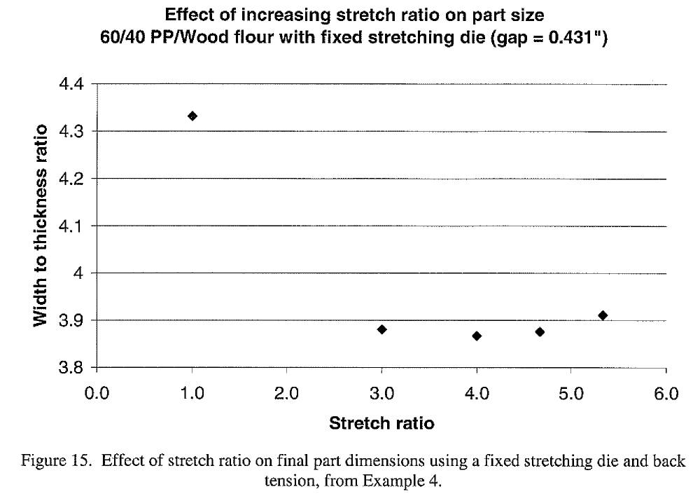

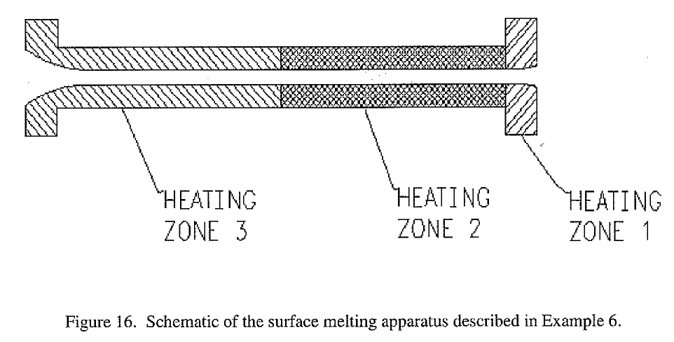

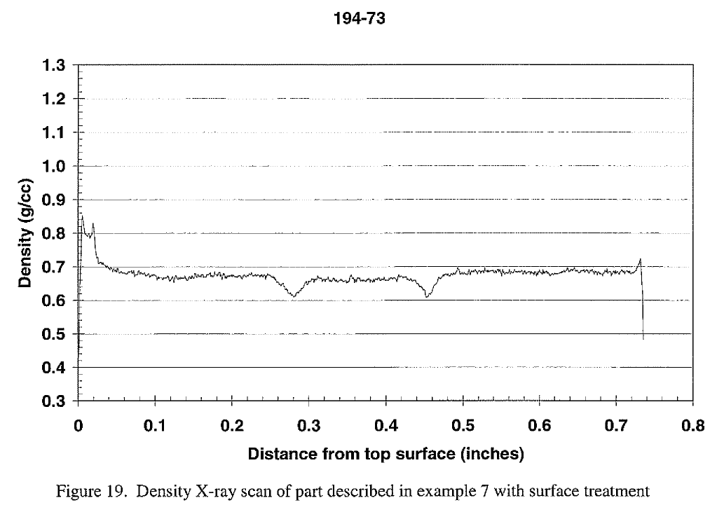

Starting material made from a mixture of 70 wt % polypropylene and 30 wt % 60# wood flour previously stretched to a ratio of 6 to 1 was passed under a 32″ infrared heater at 6 ft/min in order to melt the surface of the part. This material was immediately passed under an 8″ diameter roller at a temperature below that of the material's melting point, with smoothing and solidifying of the smelted surface. This procedure resulted in a re-melted surface of 0.085″ thick (average) on the surface of the part. The overall average density of the part was 42.1 pcf and the average density of the re-melted surface was 47.2 pcf. FIG. 17 is an electron micrograph depicting a typical surface of a pail made with the recipe described above without surface treatment. FIG. 18 is an electron micrograph illustrating the effect of non-contact heat treatment (IR) and subsequent densification on the surface of the part. FIGS. 19 and 20 display the x-ray density scans of the part surfaces with and without surface treatment as described in Example 7.

### EXAMPLE 8

Starting material made from a mixture of 70 wt % polypropylene and 30 wt % 60# wood four stretched to a ratio of 6 to 1 was passed 4 times through a heated set of 8″ diameter rollers at 10 feet per minute and a pressure of 257 pounds per linear inch of contact. The rollers were heated to a temperature above the melting point of polypropylene, about 370 degrees F. This procedure resulted in a re-melted surface of 0.0035″ thickness (average) on the surface of the part. The overall average density of the part was 40.6 pcf and the average density of the remelted surface was 44.0 pcf.

While the embodiments of the invention have been illustrated and described, as noted above, many changes can be made without departing from the spirit and scope of the invention Accordingly, the scope of the invention is not limited by the disclosure of the embodiments. Instead, the invention should be determined entirely by reference to the claims that follow.

What is claimed is:

1. A process for producing an oriented composite material, the process comprising the steps of:
i) combining an extrudable polymer with one or more fillers to form a starting material;
ii) heating and extruding the starting material into a first column;
iii) adjusting the temperature of the first column to a stretching temperature;
iv) presenting the first column to a stretching die and causing the first column to exit the stretching die in a second column having a cross-sectional area less than that of the first column wherein a back tension force is applied on the first column before the first column enters the stretching die;
v) applying a pulling force to the second column to stretch the first column through the stretching die at a rate sufficient to cause orientation of the polymer and to cause the second column to diminish in density to form the composite material.

2. The process of claim 1 wherein the one or more fillers are selected from a group consisting of: cellulosic materials, mineral fillers, engineered fillers and industrial wastes.

3. The process of claim 2 wherein the one or more fillers are at least one of gas, liquid or solid.

4. The process of claim 1 wherein the polymer is selected from the group consisting of: polyethylene, polypropylene, polyvinylchloride, polylacticacid, the members of the nylon family, polyoxymethylene, polyethylene terephthalate, polybutylene terephthalate, liquid crystal polyesters and polyethyletherketone.

5. The process of claim 4 wherein the extrudable polymer is present in an amount of from 100 to 20 percent by weight in the starting material.

6. The process of claim 1 wherein the composite material has a density of from 0.3 to 0.9 of the density of the starting material.

7. A process for producing an oriented composite material, the process comprising the steps of:
i.) combining an extrudable polymer with one or more fillers wherein each filler is in solid, liquid, or gas form, to form a starting material;
ii.) heating and extruding the starting material into a first column;
iii.) adjusting the temperature of the first column to a stretching temperature;
iv.) presenting the first column to a stretching die and causing the first column to exit the stretching die in a second column having a cross-sectional area less than that of the first column;
v.) applying a pulling force to the second column to stretch the first column through the stretching die at a rate sufficient to cause orientation of the polymer and to cause the second column to diminish in density to form the composite material.

8. The process of claim 7 further comprising the step of:
applying a back tension force to the first column before the first column enters the stretching die.

9. The process of claim 7 wherein the one or more fillers are selected from a group consisting of: cellulosic materials, mineral fillers, engineered fillers and industrial wastes.

10. The process of claim 9 wherein the one or more fillers are at least one of gas, liquid or solid.

11. The process of claim 7 wherein the polymer is selected from the group consisting of: polyethylene, polypropylene, polyvinylchloride, polylacticacid, the members of the nylon family, polyoxymethylene, polyethylene terephthalate, polybutylene terephthalate, liquid crystal polyesters and polyethyletherketone.

12. The process of claim 7 wherein the composite material has a density of from 0.3 to 0.9 of the density of the starting material.

13. The process of claim 7 wherein the extrudable polymer is present in an amount of from 95 to 20 percent by weight in the starting material.

14. A process for producing an oriented composite material, the process comprising the steps of:
i.) combining an extrudable polymer with one or more fillers wherein each filler is in solid, liquid, or gas form, to form a starting material;
ii.) heating and extruding the starting material into a first column;
iii.) adjusting the temperature of the first column to a stretching temperature;
iv.) presenting the first column to a stretching die and causing the first column to exit the stretching die in a second column having a cross-sectional area less than that of the first column wherein a back tension force is applied on the first column before the first column enters the stretching die;
v.) applying a pulling force to the second column to stretch the first column through the stretching die at a rate sufficient to cause orientation of the polymer and to cause the second column to diminish in density to form the composite material.

15. The process of claim 14 wherein the one or more fillers are selected from a group consisting of: cellulosic materials, mineral fillers, engineered fillers and industrial wastes.

16. The process of claim 14 wherein the one or more fillers are at least one of gas, liquid or solid.

17. The process of claim 14 wherein the polymer is selected from the group consisting of: polyethylene, polypropylene, polyvinylchloride, polylacticacid, the members of the nylon family, polyoxymethylene, polyethylene terephthalate, polybutylene terephthalate, liquid crystal polyesters and polyethyletherketone.

18. The process of claim 14 wherein the composite material has a density of from 0.3 to 0.9 of the density of the starting material.

19. The process of claim 14 wherein the extrudable polymer is present in an amount of from 95 to 20 percent by weight in the starting material.
